(19) United States
(12) Patent Application Publication
(10) Pub. No.: US 2014/0253725 A1
(43) Pub. Date: Sep. 11, 2014

(54) Enhanced Surveillance Camera

(71) Applicant: LKU TECHNOLOGY LTD., Taipei (TW)

(72) Inventor: Min-chieh Hsu, Taipei (TW)

(73) Assignee: LKU TECHNOLOGY LTD., Taipei (TW)

(21) Appl. No.: 13/785,006

(22) Filed: Mar. 5, 2013

(51) Int. Cl. H04N 5/225

(52) U.S. Cl. CPC H04N 5/2251
USPC 348/143

(57) ABSTRACT

A camera structure includes a power supply module, supplying power to the camera, a sensing device, positioned near the camera to detect luminance variations around the camera, a speaker, sending out sounds in situation where luminance variations are detected by the sensing device, lighting components, generating light in situations where the power supply module is disabled and the sensing device detects luminance variations and a battery module, providing back up power in situation where the power supply module is disabled.

### BACKGROUND OF THE INVENTION

1. Field of the Invention

This invention is related to an enhanced surveillance camera having sensing and alarming functions, where the sensing function is used to detect whether the camera is intentionally covered and a speaker provided on a side of the camera sends out a warning sound to intimidate the wrongdoing personnel.

2. Description of the Related Art

For solving crime cases, surveillance camera has an obvious contribution, which is not only convenient for collecting evidence during investigation, it also has intimidating effect to persons with criminal intent.

Because the surveillance cameras are placed in public areas, the intimidating effect is able to efficiently reduce the crime rate. However, just because of the recording function of the surveillance camera to the areas so covered, most of persons before committing a crime will try to cover the lens of the camera or use paint of some kind to block the lens to sabotage the normal recording function of he surveillance camera.

Obviously, the conventional camera only provides observing function and recording function, which is difficult to simultaneously prevent the camera from intentional destruction.

### SUMMARY OF THE INVENTION

The purpose of the present invention is to create a surveillance camera with additional warning function. This invention provides an enhanced surveillance camera having sensing and alarming functions, where the characteristics is related to a sensing device configured near the camera lens and a speaker combined with the camera. A control unit provided inside the camera is used to determine the sensing result of the sensing device and enable the speaker to function.

Accordingly, once the camera is intentionally covered by any objects, which is detectable by the sensing device, then the speaker simultaneously sends out sound or voice to intimidate personnel with intent, and this sort of alarming function makes the surveillance camera more powerful to reduce the crime rate.

### BRIEF DESCRIPTION OF THE DRAWINGS

The invention, as well as its many advantages, may be further understood by the following detailed description and drawings in which:

FIG. 1 is a perspective view of the surveillance camera constructed in accordance with the present invention;

FIG. 2 is a schematic view showing the application of the surveillance camera of the present invention; and

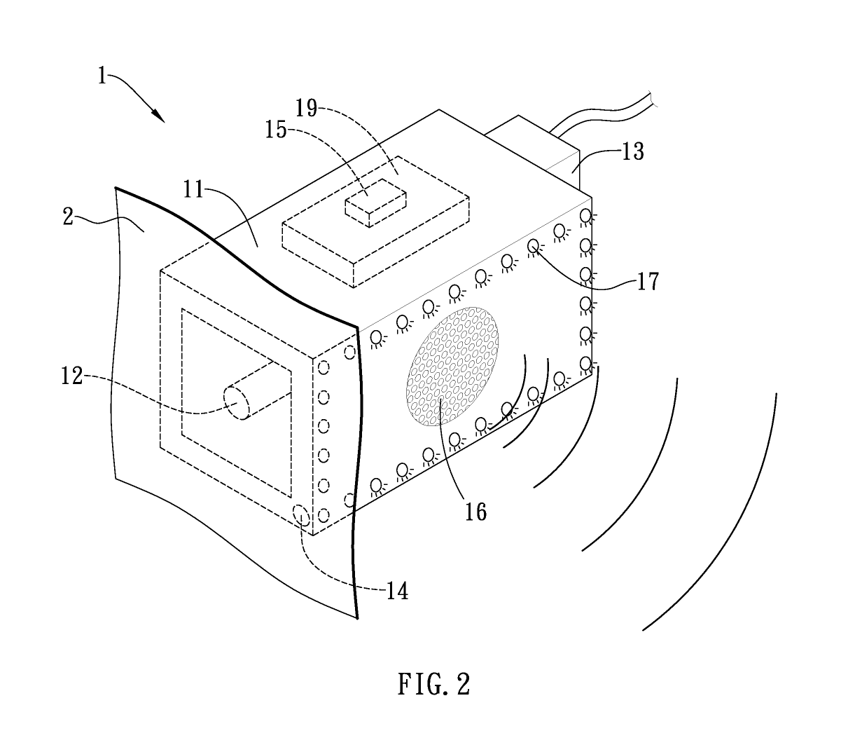

FIG. 3 is a block diagram of the surveillance camera of the present invention.

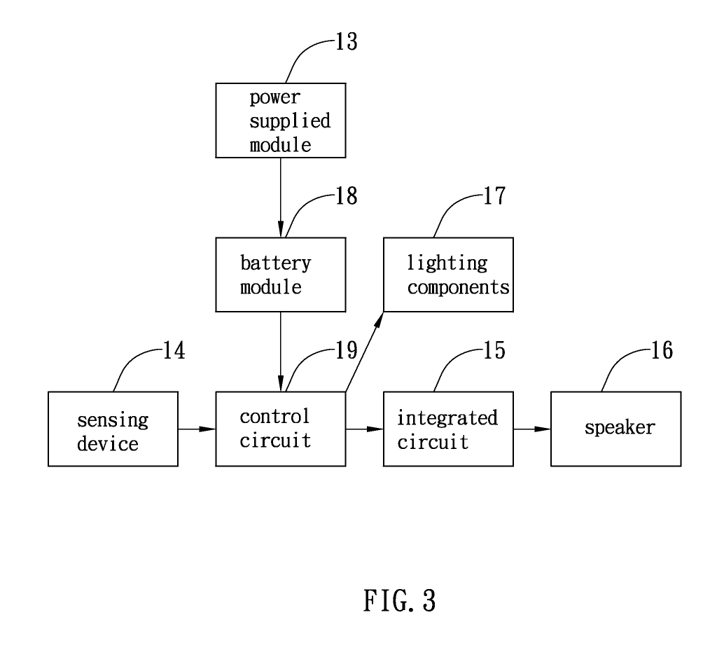

### DETAILED DESCRIPTION OF THE INVENTION

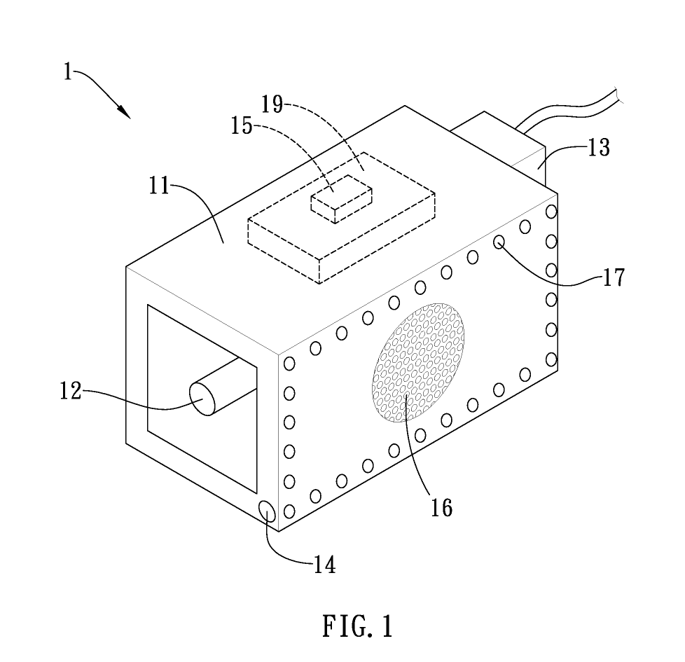

FIG. 1 discloses an enhanced surveillance camera 1 constructed in accordance with the preferred embodiment of the present invention and having sensing and alarming functions. The camera 1 includes: a shell 11, a camera 12 configured on the front of shell 11, a power supply module 13 configured on rear of shell 11, a sensing device 14 configured outside of the shell 11 near camera 12, an integrated circuit (IC) 15 configured inside the shell 11 for voice and sound processing; a speaker 16 configured on another side of the shell 11 and electrically connected to the IC 15; lighting components 17 configured on at least one side of the shell 11; a battery module 18 configured inside the shell 11 and electrically connected to the power supply module 13; and a control circuit 19 configured inside the shell 11 and electrically connected to the camera 12, the sensing device 14, the IC 15, the lighting components 17 and the battery module 18.

Specifically, the sensing device 14 configured near the camera 12 is capable of detecting whether the camera 12 is covered or blocked. In situation where the camera 12 is not covered by any objects and the sensing device 14 is also not covered, the lighting components 17 configured outside the shell 11 are green. Correspondingly, in situation where the camera 12 is covered by any objects, which is detectable by the sensing device 14. Once the sensing device 14 detects object of any kind blocking the lens of the camera 12, the sensing device 14 generates a detected signal and sends the generated signal to the control circuit 19. After the control circuit 19 receives the detected signal, the control circuit 19 generates a control signal and sends the signal to the lighting components 17 and the IC 15, where the lighting components 17 turn to red and the IC 15 further generates a media signal to initiate the speaker 16, which in turn generates a warning voice or sound.

Moreover, this preferred embodiment illustrates the battery module 18 electrically connected to the control circuit 19 and the power supply module 13. The battery module 18 is capable of storing power form power supply module 13, thereby providing an even more reliable power source for operation of the surveillance camera under the situation where the power supply module 13 is disabled because the battery module 18 is capable of sending a backup power to the control circuit 19. Depending on the backup power, the control circuit 19 generates a second control signal to the lighting components 17 and IC 15, where the lighting components 17 turn into blue and the IC 15 further generates the media signal to the speaker 16, which sends out a warning voice or sound.

In this preferred embodiment, the aforementioned sensing device 14 is a light sensor which generates detected signal depending on illumination variations near the camera 12. Thereafter, whenever there is a person intentionally covering the camera lens with such as a fabric, the sensing device 14 picks up the blocking and generates the detected signal for the control circuit 19. After the control circuit 19 receives the detected signal to enable the lighting components 17 to turn into red as well as the speaker 16 to send out warning sounds, the ill-intended person will be warned and crime is stopped.

In this preferred embodiment, the aforementioned lighting component 17 are selected from a group having LED, LCD and OLED, and the displayed color of the lighting component 17 is green in general situation, and the displayed color of the lighting component 17 turns into red in situation where the camera 12 is covered, and the displayed color of the lighting component 17 is blue in situation where the backup power is provided by the battery module 18.

In this preferred embodiment, the aforementioned warning sound coming out of the speaker 16 is a continuously repetitive sound such as ‘beep-beep-beep’ or ‘ring-ring-ring’, and the warning voice coming out of the speaker 16 is a continuously repetitive voice such as ‘attention-attention-attention’ or ‘warning-warning-warning’, so as to achieve the purpose of intimidating the ill-intended person.

In this preferred embodiment, the mentioned battery module 18 is selected from the group of lead-acid battery, nickel-hydride battery, lithium-cobalt battery, lithium-manganese battery and lithium-iron battery, which is able to provide backup power.

In summary of the description above, the enhanced camera having sensing and alarming functions is capable of warning person who intends to cover his/her trace by blocking the camera lens or to destroy the power supply module of the surveillance camera. Even in the situation that the power supplied module 13 is not working, the battery module 18 will provide backup power for camera 12, speaker 16, lighting components 17 and control circuit 19 in order to maintain the warning functions.

What is claimed is:

1. A camera structure comprising:
a camera;
a power supply module, supplying power to the camera;
a sensing device, positioned near the camera to detect luminance variations around the camera;
a speaker, sending out sounds in situation where luminance variations are detected by the sensing device;
lighting components, generating light in situations where the power supply module is disabled and the sensing device detects luminance variations; and
a battery module, providing back up power in situation where the power supply module is disabled;

2. The camera structure of claim 1, wherein the sensing device is a light sensor.

3. The camera structure of claim 1, wherein the lighting components are selected from a group consisting of LED, LCD and OLED.

4. The camera structure of claim 1, wherein the battery module is selected from a group consisting of lead-acid battery, nickel-hydride battery, lithium-cobalt battery, lithium-manganese battery and lithium-iron battery.

5. The camera structure of claim 2, wherein the lighting components are selected from a group consisting of LED, LCD and OLED.

6. The camera structure of claim 3, wherein the battery module is selected from a group consisting of lead-acid battery, nickel-hydride battery, lithium-cobalt battery, lithium-manganese battery and lithium-iron battery.

7. The camera structure of claim 4, wherein the sensing device is a light sensor.

8. The camera structure of claim 5, wherein the battery module is selected from a group consisting of lead-acid battery, nickel-hydride battery, lithium-cobalt battery, lithium-manganese battery and lithium-iron battery.
